(19) United States
(12) Patent Application Publication
(10) Pub. No.: US 2009/0246467 A1
(43) Pub. Date: Oct. 1, 2009

(54) MOLDED COARSE PARTICLE PRODUCT WITH CAST PAPER-BASED REINFORCEMENT

(76) Inventor: Pedro Delantar, JR., Las Vegas, NV (US)

Correspondence Address: FISH & RICHARDSON P.C., PO BOX 1022, MINNEAPOLIS, MN, 55440-1022, US

(21) Appl. No.: 12/360,722

(22) Filed: Jan. 27, 2009

Related U.S. Application Data
(60) Provisional application No. 61/024,478, filed on Jan. 29, 2008.

(51) Int. Cl. B32B 5/16; D21J 3/00

(52) U.S. Cl. 428/146; 162/221

(57) ABSTRACT

A molded coarse particle product adapted for use as houseware, furniture, insulation, and architectural articles and/or components made from agri-forest waste particles selected from flakes, chips, fragments, pellets, bits, shreddings, mulch, and strands, and mixtures thereof The particles are admixed and boded together with a binder an lightly pressed into a mold preferably manually or automatically, together with a reinforcing means characterized in that the reinforcing means is a biodegradable paper-based cast material integrally bonded to the molded product forming a backing and/or reinforcing layer, making said product durable and substantially biodegradable.

### CROSS-REFERENCE TO RELATED APPLICATIONS

This application claims the benefit of U.S. Provisional Application Ser. No. 61/024,478, filed Jan. 29, 2008. The disclosure of the prior application is considered part of (and is incorporated by reference in) the disclosure of this application.

### TECHNICAL FIELD

The present document generally relates to molded shaped articles particularly made from agri-forest waste particles. It relates to a durable and biodegradable molded coarse particle product made from agri-forest waste particles having cast paper-based reinforcement serving as a backing and/or reinforcing layer.

### BACKGROUND

Environmentally “friendly” products are often produced in ways that reduce strain on the availability of natural resources. These products can incorporate recycled materials, for example, greatly eliminating the need to consume raw materials to produce the product. In recent years, consumers have demanded more and more environmentally-friendly products in an effort to reduce the impact of humanity on global environmental health. In many regions of the world, being “environmentally conscious” has grown into a consumer trend, where some shoppers actively seek out products, such as sustainably-grown crops, or recycled items because they believe doing so contributes to the greater good of our world.

Deforestation is one particular topic receiving a great deal of attention because it is believed to be affecting the Earth's atmosphere as well as reducing the protective cover and habitat for many animal species. In an effort to reduce the amount of trees downed each year for our consumption, many business and homes participate in paper recycling programs. In addition, so-called “faux” wood products, such as decking and the like, reduce the amount of actual wood used from trees by supplementing the product with plastics.

### SUMMARY

In one general aspect, a molded coarse particle product made in part from agri-forest waste particles is provided. In general, the products can be manifest in various forms. For example, the products can be formed into house-wares, furniture, insulation, and architectural articles and/or components such as decorative tiles, ornamental vases, garden accessories or the like. In one embodiment, a molded coarse particle product can be supplemented with a durable and biodegradable paper-based cast reinforcing material that can also serve as a backing layer.

In one general aspect, a molded coarse particle product is provided. The molded coarse particle product can include a mixture of particles and a binder. The particle/binder admixture can be shaped into a desired form. The form can be strengthened and made durable by applying a paper-based reinforcing material integrally bonded to the form, thereby forming a backing or reinforcing layer, making the product durable and substantially biodegradable.

The paper-based reinforcing material can be sourced from waste paper items such as newspaper, magazine, used office paper, used carton, and/or old paper books, among others equally-viable options. In one embodiment, the paper-based reinforcing material can be created by forming a castable mixture that includes both a paper source and a water-based binder. The castable mixture can be prepared by mixing and kneading the paper together with the water-based binder until the castable mixture becomes a substantially fibrous and paste-like. The paper can be torn into bits and pieces before mixing it with the binder.

The paper can be wetted, for example, to a saturation point, before mixing the paper with the binder. For example, the paper may be wetted by sprinkling just enough water to be fully absorbed by the paper. In some cases, the paper can be soaked in a bucket of water and thereafter removing any excess water to obtain a saturated wet paper.

In one general aspect, a method of manufacturing a selectably-rigid, durable, and biodegrable molded coarse particle product is provided, the molded coarse particle product having a cast paper-based reinforcing material that serves as a backing layer.

In one embodiment, a molded coarse particle product can be created by hand. A supply of particles, for example, small bits or pieces of wood from a fallen tree, can be mixed with a water-based binder such as a polyester resin, or a polyvinyl acetate-based glue such as Elmer's® glue, and formed into a mold. A paper reinforcing material of the type described above may then be applied to the mold and allowed to dry and adhere to the mold.

In one general aspect, a durable and biodegradable molded coarse particle product for use as houseware, furniture, insulation, and architectural articles and/or components that is very economical and most practical to manufacture is provided. The molded coarse particle product utilizes simple technology or craftsmanship for converting agri-forest waste materials and recycled used paper into useful molded shaped articles.

The details of one or more embodiments are set forth in the accompanying drawings and the description below. Other features, objects, and advantages will be apparent from the description and drawings, and from the claims.

### DESCRIPTION OF DRAWINGS

FIG. 1 is a cut-away, plan view of an embodiment or illustrative example of the invention.

FIG. 2 is an enlarged, cross-sectional view thereof taken along line 2-2 of FIG. 1.

FIG. 3A is a photograph of a coarse particle product being characterized in part by the following description.

FIG. 3B is close-up view of the coarse particle product shown in FIG. 3A.

### DETAILED DESCRIPTION

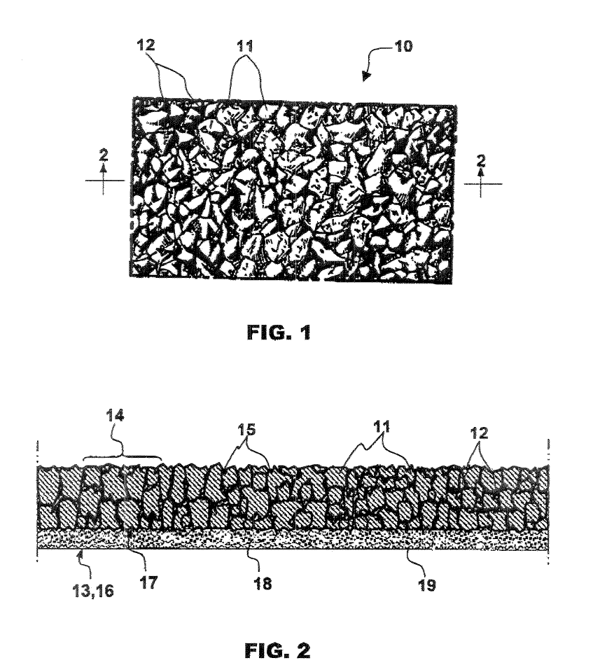

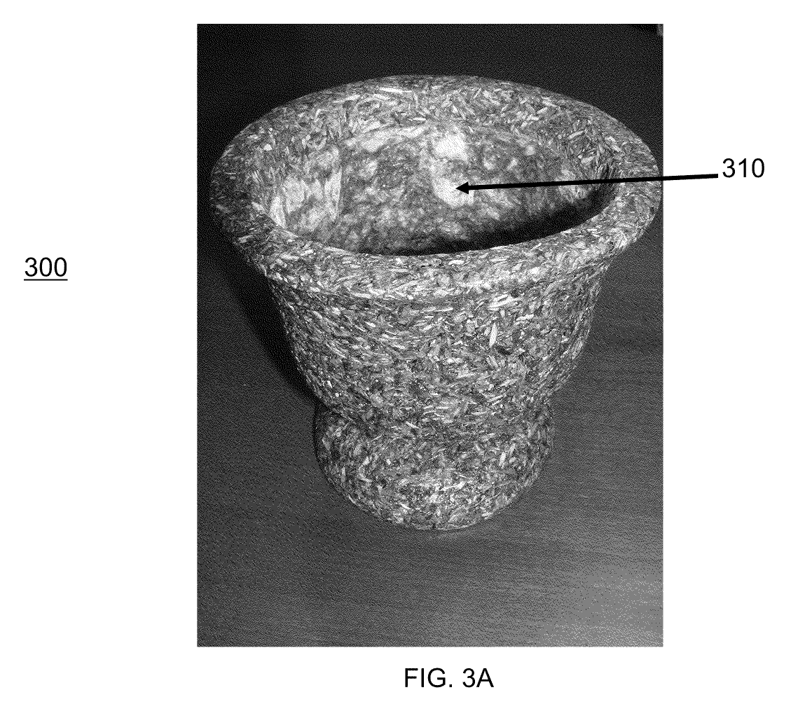

Referring now to the drawing in which like reference numerals designate the same parts or elements all throughout the succeeding description, there is shown in FIG. 1 a cut-away view of an illustrative example of a molded coarse particle product for use as house-wares, furniture, insulation, architectural components or the like generally designated by reference numeral. For purposes of this description, “Molded coarse particle product” refers to a molded shaped article made of bits and pieces of agri-forest waste particles 11 of random irregular sizes bonded together with a binder 12 and lightly cold-pressed into a mold (not shown), together with a reinforcing material 13 forming a shaped article. The agri-forest waste particles 11 can be in the form of flakes, chips, fragments, pellets, bits, shredding, mulch, and/or strands which when lightly pressed and bonded together form a coarse outer layer surface 14 having interstices/concavities 15 randomly disposed partly between bonded particles 11.

The molded coarse particle product or article 10 can include a paper-based reinforcement layer 16 as the reinforcing material 13, that is cast and bonded directly to the inner back side 17 of the molded article or product 10. The paper-based reinforcement layer 16 can be composed of a paper-based material 18 that has been reduced to a fibrous pulp-like texture by mixing and kneading together paper and a binder, preferably, a water-based binder 19.

The paper-based material 16 can be sourced from newspaper, magazine, used paper, used office paper, used carton, and/or old paper books, although any source of fiber is considered plausible in the preparation of the instant products. The paper material can be highly water-absorbent and capable of being torn into pieces and converted easily to a fibrous pulp-like texture through kneading process. Doing so may affect the strength and durability of the paper-based reinforcing material to a selectable extent. For example, a smooth paste, i.e., a highly-processed mixture, of the paper-based reinforcing material may provide increased strength, owing to increased surface area exposed to the paper fibers and the binder. A smooth paste may also provide an aesthetic quality desirable in certain applications. In some cases, a rough paste may provide a certain amount of flexibility in the paper-based reinforcing material that may be desirable in certain applications. A rough texture may similarly provide a chosen aesthetic quality for a given product.

In one embodiment, old newspaper can be used as the paper source, as it can absorb water and/or binder relatively quickly, and is soft. Thus, it may be easy to reduce into a pulp-like texture. If the size of the paper is too large, like, for example, a standard newspaper, it can be torn into small sizes. Preferably, size of the paper is reduced into 1 to 4 cm pieces to facilitate easy mixing and kneading process.

The binder 19 can be a viscous adhesive glue, such as a polyvinyl acetate-based glue. Elmer's Glue™, and PVA glue are examples of preferable binders 19. In some embodiments, it may be preferable to use a biodegradable.

In some embodiments, the paper-based reinforcement layer 16 can be directly adhered and cast to the inner back side 17 of the molded product or shaped article 10.

In one general aspect, the reinforcing material can be prepared by: (a) mixing a binder to paper, preferably, cut into small pieces, (b) kneading the mixture of paper and the binder until it becomes a homogenous mixture. At this point the paper may become pulp-like, thereby producing a castable paste-like mixture.

In one embodiment, the supplied paper has been wetted, preferably to saturation point, before being mixed with the binder.

One or more layers of the castable paste-like mixture can be applied directly to a surface of the molded article, for example, the inner back side 17 of the molded article 10. The applied mixture is allowed to dry, preferably at ambient temperature, wherein it is further integrally bonded with the molded article 10, forming an inner backing and reinforcement layer 16 thereto. A substantially durable and biodegradable molded coarse particle product or shaped article 10 is thereby produced.

The molded coarse particle product or shaped article 10 can have various applications as houseware articles, ornamental vases, utility box/container/receptacles, furniture components, decorative wall hangers, coverings or facings, among many others. In any of these applications, the product 10 can be adopted in combination with other components made of different materials such as metal frames, cast stone bases, complementary architectural components or any other desired elements or structures. The product can be preferably treated as normally or conventionally practiced in the handicraft industry especially for wooden articles to protect it against material damage due to environmental adversities such as temperature changes, improper handling, damage caused by insects, etc. For further surface protection purposes and design preferences, the product 10 can also be preferably provided in part or in its entirety with a finishing, protecting or enclosing layer.

The products described herein can generally be environment-friendly as they are substantially made from biodegradable waste materials, that is, agri-forest waste particles and used paper-based materials.

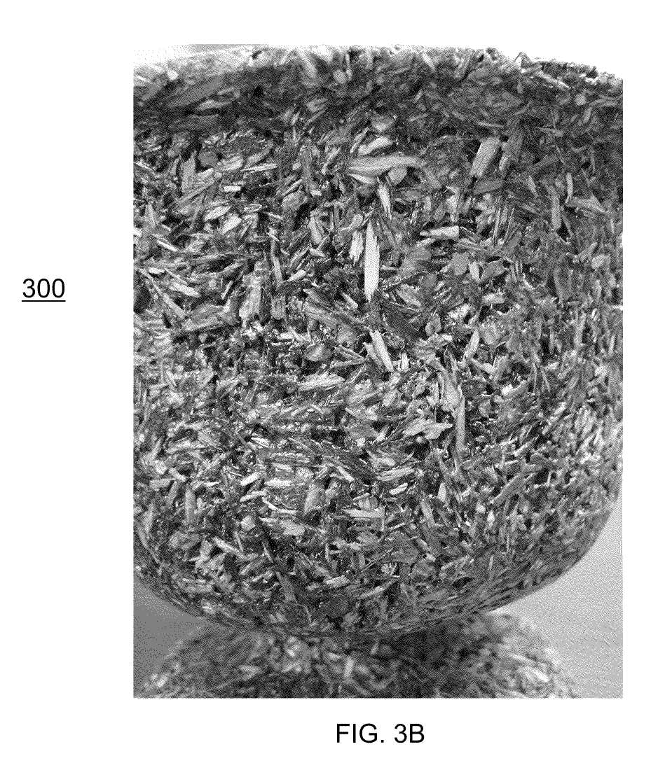

FIG. 3A is a photograph of a coarse particle product 300 according to the features described herein. The coarse particle product 300 includes a paper-based reinforcement layer 310, generally indicated by the arrow, and extending throughout the interior of the vase.

FIG. 3B is a close-up view of a coarse particle product 300, showing the details of the particles incorporated into the molded product.

A number of embodiments have been described. Nevertheless, it will be understood that various modifications may be made without departing from the spirit and scope of the contents of this document. For example, the coarse particle products described herein can be made by hand or by automated processes. In some embodiments, any naturally-occurring material can be integrated into a coarse particle product; non-limiting examples include tree parts, including bark, trunk, limb, twig, leaf, etc. In some embodiments, rocks or other minerals can be used as the particles. Accordingly, other embodiments are within the scope of the following claims.

What is claimed is:

1. An article, comprising:
whole pieces or particles of a naturally-occurring material;
a binder; and
a fibrous reinforcement layer, comprising a mixture of a paper fiber and the binder blended into a pressable paste;
wherein the whole pieces or particles of naturally-occuring material and the binder are formed into a shape, and the fibrous reinforcement layer provides added structural strength to the shape.

2. A molded coarse particle product for use as housewares, furniture, insulation, and architectural articles and/or components comprising agri-forest waste particles of random irregular sizes bonded together with a binder and lightly cold pressed into a mold to form a desired shaped article, and a reinforcing means being integrally bonded thereto; characterized in that the reinforcing means is a paper-based layer, directly cast and bonded to the molded product forming a durable and biodegradable backing and reinforcing inner layer.

3. A product according to claim 2, wherein the cast paper-based reinforcing means comprises of waste material reduced into small bits and pieces characterized by a fibrous pulp-like texture when mixed and kneaded thoroughly with a water-based binder.

4. A product according to claim 3, wherein the waste material is selected from newspaper, magazine, used paper, used cartons, old paper books, and mixtures thereof.

5. A product according to claim 2, wherein the waste material is selected from newspaper, magazine, used paper, used cartons, old paper books, and mixtures thereof.

6. A product according to claim 2, wherein said agri-forest waste particles are in the form of flakes, chips, fragments, pellets, bits, shreddings, mulch, and/or strands that form into a coarse outer layer surface of the product having interstices/concavities randomly disposed partly between bonded particles.

7. A method of making a molded coarse particle product having reinforcement comprising the steps of admixing a binder to agri-forest waste particles forming a mass of binder-coated particles, lightly pressing the binder coated particles into a pre-waxed mold forming a shaped molded article having a coarse outer surface characterized by interstices randomly formed partly between bonded particles, allowing the molded article to dry in the mold, removing the molded article from the mold, applying at least a layer of reinforcement material to the inner side of the molded article, and drying further the reinforced molded article; characterized in that the reinforcement layer is a biodegradable paper-based cast material made by (a) mixing paper and binder, (b) kneading the paper and binder homogenously until the paper attains a fibrous pulp-like texture thereby producing a castable paste-like mixture.

8. A method according to claim 7, wherein the binder is a water-based adhesive binder.

9. A method according to claim 7 further comprising wetting the paper to saturation point with water before mixing the paper with the binder.

10. A method according to claim 7, wherein the paper is torn into small pieces before mixing the paper with the binder.

11. A method according to claim 8, wherein the paper is torn into small pieces before mixing the paper with the binder.

12. A method according to claim 9, wherein the paper is torn into small pieces before mixing the paper with the binder.

13. A method according to claim 7, wherein the reinforced molded product is provided with a finishing, protecting or enclosing layer.

14. A method according to claim 8, wherein the reinforced molded product is provided with a finishing, protecting or enclosing layer.

15. The article of claim 1, wherein the naturally-occurring material is selected from the group consisting of: tree parts, shrubs, and rocks.
